(19) United States
(12) Patent Application Publication
(10) Pub. No.: US 2009/0008287 A1
(43) Pub. Date: Jan. 8, 2009

(54) Packaged Infant Care Products

(75) Inventor: Gregory R. Viggiano, Alexandria, VA (US)

Correspondence Address: SHOEMAKER AND MATTARE, LTD, 10 POST OFFICE ROAD - SUITE 110, SILVER SPRING, MD, 20910, US

(73) Assignee: TRIO CHILD, LLC, Alexandria, VA (US)

(21) Appl. No.: 11/773,245

(22) Filed: Jul. 3, 2007

(51) Int. Cl. A45C 11/20; A61J 9/00; A61J 9/08; B65D 69/00

(52) U.S. Cl. 206/541; 206/223; 215/11.1; 215/11.4; 215/11.6

(57) ABSTRACT

A container of sterilized fluoridated water, powdered infant formula, and a ready-to-use sterile feeding nipple are hermetically sealed within an enveloping structure. Once the structure is opened, the water and formula are removed, the formula is dissolved in the water in the bottle, and the nipple is then applied to the bottle. The used components may be placed back in the container for reuse or disposal by reapplying an outer lid. In a preferred embodiment, the enveloping structure is a cylindrical can and the water container is a bottle which is centered within the can by indentations in the wall of the can.

### BACKGROUND OF THE INVENTION

This invention relates to packaged infant care products.

New parents encounter many situations in which it is impossible or inconvenient to keep natural milk on hand for their infants. Infant formula is an alternative in such situations, but even formula spoils and spills. It would be useful to have an infant formula package which had a long shelf life, was easy to crate, ship and carry, and contained everything necessary to mix and feed the formula.

### SUMMARY OF THE INVENTION

An object of the invention is to provide a convenient package containing everything needed to prepare and feed infant formula.

Another object is to provide a sealed system which will keep indefinitely and is easily stored and crated.

These and other objects are attained by a packaged infant care product as described below.

### BRIEF DESCRIPTION OF THE DRAWINGS

In the accompanying drawings,

FIG. 1 is a perspective view of packaged infant care products embodying the invention;

FIG. 2 is an exploded view showing the component products; and

FIG. 3 shows a bottle of mixed formula with a feeding nipple being installed.

### DESCRIPTION OF THE PREFERRED EMBODIMENT

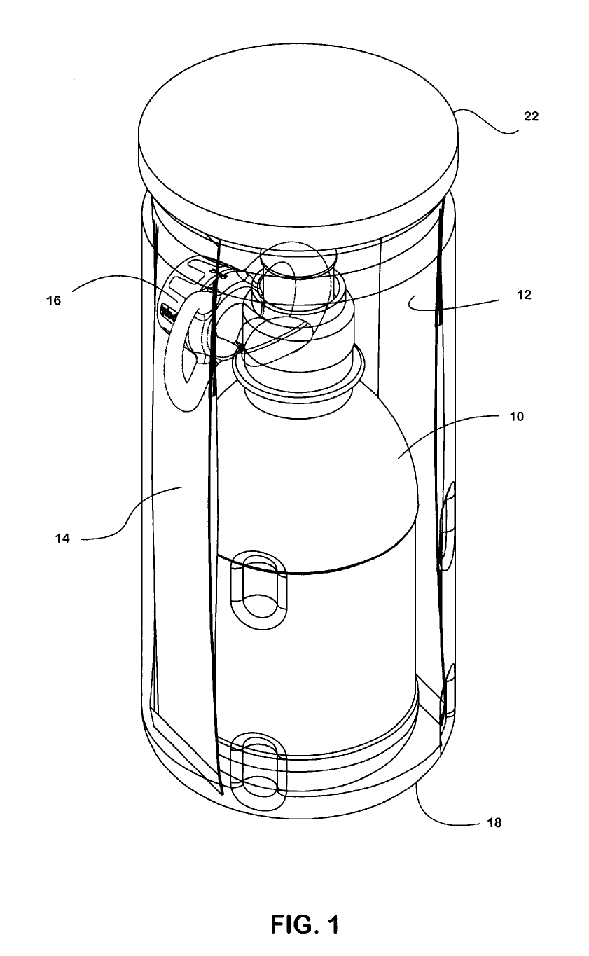

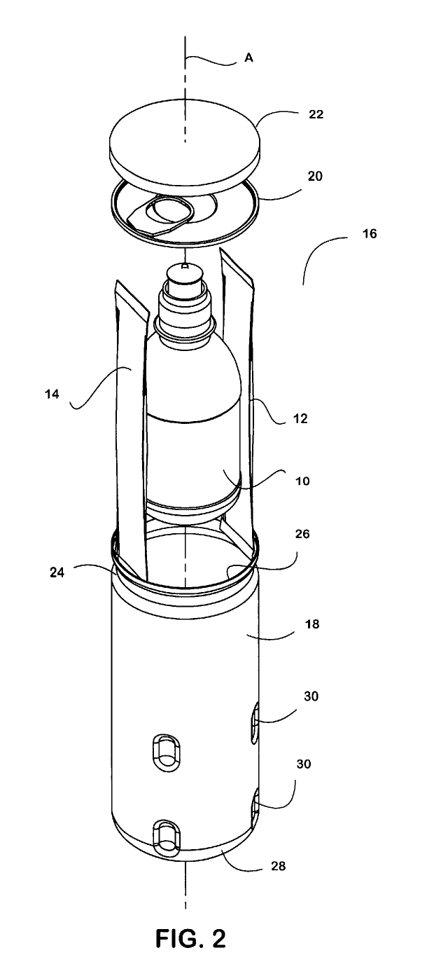

One embodiment of packaged infant care products embodying the invention is shown in FIG. 1. The products in this embodiment are a bottle of water 10, a pair of infant formula packets 12, 14, and a package, pre-sterilized nipple or nipple/pacifier 16, all placed within an enveloping structure which in this case is an open-mouthed container 18 hermetically sealed, initially, by a tamper-evident pull top seal 20 (see FIG. 2) which is overcovered with a snap-on plastic lid 22. The seal can be, for example, a foil panel with a peripheral tear line and may have a integral or attached tab or other structure which one can use to break the seal.

The container is substantially cylindrical, having a slight neck 24 just below its mouth 26. The bottom 28 of the container is dished upward. Three or more pairs of indentations 30 are formed in the side wall of the container to stabilize the water bottle and define an annular space between the bottle and container into which powdered infant formula packets may be inserted. In their presently preferred form, the indentations extend lengthwise of the container, parallel to its axis “A”. The indentations might be replaced by other structures, for example, separate spacers placed inside the outer structure, possibly adhered to its inner surface.

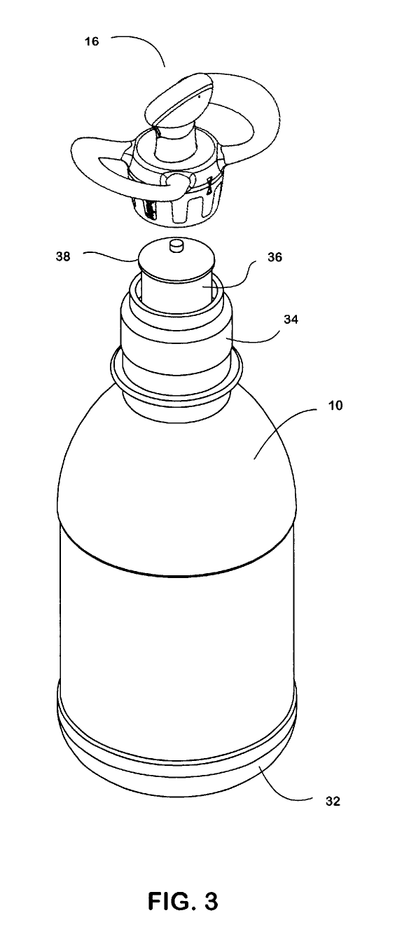

Another type of container, for example, a bag or box, could be substituted for the water bottle 10 illustrated in FIG. 1. That bottle is a conventional plastic bottle having an outer diameter substantially less than the inner diameter of the outer container. Its bottom 32 is upwardly convex so that it tends to center itself on the raised bottom 28 of the container. The bottle contains sterile water—preferably fluoridated water—and is sealed by, preferably, a tamper-evident cap 34 (FIG. 3) having a push-pull valve 36. The valve, which has a circumferential flange 38 at its top, is closed when the valve is in its initial lower position, and opens when the valve is pulled to its upward position. The inner details of the valve are not critical to this invention, and an alternative valve, for example one which is twisted to open and close it, may be substituted.

The lid 22 has an internal circumferential ridge (not shown) designed so that the lid can be pulled off the top of the container and to hold the lid on once it is replaced on the container. The lid enables one to store the formula temporarily, and makes a convenient receptacle for disposing of the packaging components later following use. Any other type of lid may be used as an alternative. One suitable example would be a e.g., a screw-off lid. Others may occur to skilled people.

The pull top 20 shown in FIG. 1 is conventional. U.S. Patent 6640993, the disclosure of which is incorporated herein, contains a detailed description of a suitable pull top container for a wide-mouthed container. It should be understood, however, that other types of sealing structures are within the scope of this invention. For example, the sealing structure could be a panel defined by a tear line but only partially removable from the outer container. The selection of a particular type of sealing structure is a matter of ordinary skill.

The nipple/pacifier 16 is designed to snap onto the circumferential flange 38 of the bottle cap's valve. Details of a suitable nipple/pacifier may be found in U.S. Pat. No. 7,032,764, the disclosure of which is incorporated herein by reference. Again, however, this is but one example of a suitable nipple device, and many others—including those not having a pacifier function—may prove suitable. The nipple device is preferably provided wrapped in a sealed bag to maintain the sterile condition of the nipple until it is used.

The dry formula packets 12, 14 may be foil packets having a tear-off end and containing, in all, the proper amount of dry formula to mix with the contents of the water bottle. Similac Advance® formula is an example of a suitable product. Alternatively, the formula may be contained in any other suitable sealed container, including but not limited to a vial, bottle, box or closed straw. Also, the formula may be provided in a non-powdered form, for example in the form of a paste, tape, pill or tablet.

The pull top 20 seals the container hermetically so that it can be stored indefinitely.

Once the container is opened by breaking the seal 20, the water bottle 10 and formula packets 12, 14 can be removed. The cap is then removed from the bottle, and the contents of the formula packets are poured into the bottle and mixed by shaking the bottle after the cap has been replaced. A funnel or the like may be included with one of the elements to facilitate pouring. Now the nipple/pacifier is pushed onto the valve of the bottle in which the formula has been placed, and the bottle is shaken to mix the formula.

Once feeding is over, the nipple may be used as a pacifier, if it has a closable airway.

The invention is subject to many modifications and variation. For example, the outer container may be any type of enveloping structure, including a bag such as a Zip-Lok® bag, a box, a blister pack or the like. Additionally, the outer structure might not be hermetically sealed, although that is certainly preferred, inasmuch as the contents are individually wrapped. Moreover, the invention may be practiced by including elements other than those described, such as Velcro® attachments, elastic bands, instructional material and the like. Therefore, the foregoing description and the accompanying drawings should be understood to describe but one example of the invention defined more generally by the following claims.

I claim:

1. An infant formula feeding kit comprising, in combination,
a container of sterile water,
a quantity of infant formula,
a nipple device attachable to the container,
an enveloping structure housing the container, the formula and the sterile nipple device.

2. The invention of claim 1, wherein the container of water is a bottle.

3. The invention of claim 1, wherein the container of water comprises a bag.

4. The invention of claim 1, wherein the container of water is a box.

5. The invention of claim 2, wherein the bottle has a closure.

6. The invention of claim 5, wherein the closure has a tamper-evident feature.

7. The invention of claim 5, wherein the closure has a valve which can be opened to release water from the container and closed to prevent leakage of water from the container.

8. The invention of claim 7, wherein the valve is a push-pull valve.

9. The invention of claim 7, wherein the valve is a rotary valve.

10. The invention of claim 5, wherein the closure includes a spout.

11. The invention of claim 10, wherein the spout have a circumferential outwardly protruding flange.

12. The invention of claim 11, wherein the nipple device is designed to pushed onto the spout and to be retained thereon by the spout's outward protruding flange.

13. The invention of claim 1, wherein the infant formula is a powder.

14. The invention of claim 13, wherein the powder is within a sealed container.

15. The invention of claim 14, wherein the sealed container is a flexible packet.

16. The invention of claim 14, wherein the sealed container is a straw, vial, bottle or box.

17. The invention of claim 13, wherein the sealed container of infant formula is disposed inside the container of water.

18. The invention of claim 1, wherein the infant formula is in the form of a dissolvable strip.

19. The invention of claim 1, wherein the infant formula is in the form of a dissolvable pill or capsule.

20. The invention of claim 1, wherein the infant formula is in the form of a paste.

21. The invention of claim 1, wherein the nipple device is a sterile nipple.

22. The invention of claim 21, wherein the sterile nipple is sealed within a sterile envelope inside the enveloping structure.

23. The invention of claim 1, wherein the nipple device is a combined sterile nipple and pacifier.

24. The invention of claim 1, wherein the enveloping structure is a bag.

25. The invention of claim 1, wherein the enveloping structure is a box.

26. The invention of claim 1, wherein the enveloping structure is substantially rigid.

27. The invention of claim 26, wherein the enveloping structure is substantially cylindrical.

28. The invention of claim 26, wherein the container has a side wall with a plurality of indentations therein, the indentations reaching substantially to the external diameter of the water bottle, so as to keep the bottle centered in the container.

29. The invention of claim 1, wherein the enveloping structure has an opening, initially sealed by a removable sealing structure, through which the water, formula and nipple can be withdrawn once the sealing structure has been opened.

30. The invention of claim 29, wherein the sealing structure is joined to the enveloping structure along a tear line.

31. The invention of claim 30, wherein the sealing structure is a tear-out panel.

32. The invention of claim 1, further comprising a replaceable lid for reclosing the container after the sealing structure has been removed.

33. The invention of claim 32 wherein the replaceable lid is a snap-off lid.

34. The invention of claim 32 wherein the replaceable lid is a screw-off lid.

35. The invention of claim 1, wherein the water is fluoridated.

36. An infant formula feeding kit comprising, in combination,
a container containing liquid infant formula,
a nipple device attachable to the container,
an enveloping structure housing the container and the sterile nipple device.
